(19) United States
(12) Patent Application Publication
(10) Pub. No.: US 2023/0342776 A1
(43) Pub. Date: Oct. 26, 2023

(54) COMBINED TOKEN AND VALUE ASSESSMENT PROCESSING

(71) Applicant: Visa International Service Association, San Francisco, CA (US)

(72) Inventors: Christopher O'Kane, Maghera (GB); Kevin White, Donaghadee (GB); Rhidian Desmond Thomas John, Helen's Bay (GB); Nathan Morgan, Georgetown, TX (US)

(21) Appl. No.: 17/763,560

(22) PCT Filed: Oct. 18, 2019
(86) PCT No.: PCT/US2019/058389

§ 371 Date: Mar. 24, 2022

(51) Int. Cl. G06Q 20/40

(52) U.S. Cl. CPC G06Q 20/401

(57) ABSTRACT

A method is disclosed. The method includes receiving interaction data for an interaction with a resource provider interacting with an access device, and responsive to receiving the interaction data, transmitting a network token request message to a token service computer. The method also includes receiving, from the token service computer, a network token response message comprising a network access token, and obtaining a supplemental access token associated with the network access token. The method also includes transmitting a value inquiry message comprising the supplemental access token to a value assessment computer, receiving a value inquiry response message comprising a value indicator from the value assessment computer, and initiating generating an authorization request message comprising an interaction amount that is based at least in part on the value indicator in the value inquiry response message.

### CROSS-REFERENCES TO RELATED APPLICATIONS

None.

### BACKGROUND

Many different loyalty schemes can exist for different resources providers. A loyalty scheme may include the accrual of points or other value by users after making purchases at a specific merchant. While such schemes can be effective, they often require a resource provider to build its own infrastructure. This can be resource intensive and time consuming from a global perspective, since many different resource providers (e.g., different merchants) exist. For example, if there are 1000 different resource providers, then each of those resources providers has to create their own loyalty system and loyalty processing scheme.

Furthermore, in a conventional system, a resource provider may maintain databases of loyalty account identifiers and payment account identifiers. Similar to the above problem, at an individual level, maintaining separate databases and security for both loyalty account identifiers and payment account identifiers is time and resource intensive.

Embodiments of the invention address these and other problems individually and collectively.

### BRIEF SUMMARY

One embodiment includes a method including: receiving, by a gateway computer, interaction data for an interaction with a resource provider interacting with an access device; responsive to receiving the interaction data, transmitting, by the gateway computer, a network token request message to a token service computer; receiving, by the gateway computer from the token service computer, a network token response message comprising a network access token; obtaining, by the gateway computer, a supplemental access token associated with the network access token; transmitting, by the gateway computer, a value inquiry message comprising the supplemental access token to a value assessment computer; receiving, by the gateway computer, a value inquiry response message comprising a value indicator from the value assessment computer; and initiating generating, by the gateway computer, an authorization request message comprising an interaction amount that is based at least in part on the value indicator in the value inquiry response message.

Another embodiment includes a gateway computer comprising: a processor; and a non-transitory computer readable medium, wherein the non-transitory computer readable medium comprises code, executable by the processor for implementing a method comprising: receiving interaction data for an interaction with a resource provider interacting with an access device; responsive to receiving the interaction data, transmitting a network token request message to a token service computer; receiving, from the token service computer, a network token response message comprising a network access token; obtaining a supplemental access token associated with the network access token; transmitting a value inquiry message comprising the supplemental access token to a value assessment computer; receiving a value inquiry response message comprising a value indicator from the value assessment computer; and initiating generating an authorization request message comprising an interaction amount that is based at least in part on the value indicator in the value inquiry response message.

Another embodiment includes a method comprising: transmitting, by a resource provider computer, interaction data to a gateway computer; in response to transmitting the interaction data to the gateway computer, receiving, by the resource provider computer from the gateway computer, a value indicator; generating, by the resource provider computer, an authorization request message comprising a supplemental access token; and transmitting, by the resource provider computer, the authorization request message to the gateway computer, which modifies the authorization request message to include a network access token associated with the supplemental access token and transmits the modified authorization request message to an authorizing entity computer for authorization.

Another embodiment of the invention includes a resource provider computer comprising a processor; and a non-transitory computer readable medium, wherein the non-transitory computer readable medium comprises code, executable by the processor for implementing a method comprising: transmitting interaction data to a gateway computer; in response to transmitting the interaction data to the gateway computer, receiving, from the gateway computer, a value indicator; generating, by the resource provider computer, an authorization request message comprising a supplemental access token; and transmitting the authorization request message to the gateway computer, which modifies the authorization request message to include a network access token associated with the supplemental access token and transmits the modified authorization request message to an authorizing entity computer for authorization.

Further details regarding embodiments of the invention can be found in the Detailed Description and the Figures.

### BRIEF DESCRIPTION OF THE DRAWINGS

FIG. 1 shows a block diagram of a system along with a process flow according to an embodiment.

FIG. 2 shows block diagram of an access device according to an embodiment.

FIG. 3 shows a block diagram of a gateway computer according to an embodiment.

FIG. 4 shows a block diagram of a token service computer according to an embodiment.

FIG. 5 shows a block diagram of a value assessment computer according to an embodiment.

FIG. 6 shows a block diagram of a resource provider computer according to an embodiment.

FIG. 7 shows a diagram illustrating relationships between a supplemental access token and other information.

### DETAILED DESCRIPTION

Prior to discussing embodiments of the invention, some terms can be described in further detail.

An “access device” may be any suitable device that provides access to an external computer. An access device may be in any suitable form. In some examples, an access device may be a private device operated by a user. In other embodiments, the access device may be a device such as an access terminal (e.g., a transit fare gate or a POS terminal) that is operated by a resource provider. Some examples of access devices include vending machines, kiosks, POS or point of sale devices (e.g., POS terminals), cellular phones, PDAs, personal or laptop computers (PCs), tablet PCs, hand-held specialized readers, set-top boxes, electronic cash registers (ECRs), automated teller machines (ATMs), virtual cash registers (VCRs), and the like.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

A “resource provider” may be an entity that can provide a resource such as goods, services, information, and/or access to a location (e.g., a parking space, a transit terminal, etc.). Examples of resource providers include merchants, governmental authorities, secure data providers, etc. A resource provider may operate one or more access devices.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “mobile communication device” may comprise any suitable electronic device that may be transported and operated by a user, which may also optionally provide remote communication capabilities to a network. Examples of remote communication capabilities include using a mobile phone (wireless) network, wireless data network (e.g. 3G, 4G or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g. cellular phones), PDAs, tablet computers, net books, laptop computers, wearable devices (e.g., watches), vehicles such as automobiles and motorcycles, personal music players, hand-held specialized readers, etc. A mobile communication device may comprise any suitable hardware and software for performing such functions, and may also include multiple devices or components (e.g. when a device has remote access to a network by tethering to another device—i.e. using the other device as a modem—both devices taken together may be considered a single mobile communication device).

A “user” may include an individual. In some embodiments, a user may be associated with one or more personal accounts and/or user devices.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CW and dCW values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “token service computer” can include a system that that services tokens. In some embodiments, a token service computer can facilitate requesting, determining (e.g., generating) and/or issuing tokens, as well as maintaining an established mapping of tokens to primary account numbers (PANs) in a repository (e.g. token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by de-tokenizing the token to obtain the actual PAN.

A “token domain” may indicate an area and/or circumstance in which a token can be used. Examples of the token domain may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e. token domain restriction controls) may be established as part of token issuance by the token service computer that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

A “token expiry date” may include the expiration date/time of the token. The token expiry date may be passed among the entities of the tokenization ecosystem during transaction processing to ensure interoperability. The token expiration date may be a numeric value (e.g. a 4-digit numeric value). In some embodiments, the token expiry date can be expressed as a time duration as measured from the time of issuance.

A “token request message” may be an electronic message for requesting a token. A token request message may include information usable for identifying a payment account or digital wallet, and/or information for generating a payment token. For example, a token request message may include payment credentials, mobile communication device identification information (e.g. a phone number or MSISDN), a digital wallet identifier, information identifying a tokenization service provider, a merchant identifier, a cryptogram, and/or any other suitable information. Information included in a token request message can be encrypted (e.g., with an issuer-specific key). In some embodiments, the token request message may include a flag or other indicator specifying that the message is a token request message.

A “token response message” may be a message that responds to a token request. A token response message may include an indication that a token request was approved or denied. A token response message may also include a payment token, mobile communication device identification information (e.g. a phone number or MSISDN), a digital wallet identifier, information identifying a tokenization service provider, a merchant identifier, a cryptogram, and/or any other suitable information. Information included in a token response message can be encrypted (e.g., with an issuer-specific key). In some embodiments, the token response message may include a flag or other indicator specifying that the message is a token response message.

“Interaction data” may include any suitable data related to an interaction that is occurring. Interaction data may include one or more of transaction data such as real credentials, tokens, information regarding one or more resources to be obtained, an initial amount for a transaction, a resource provider identifier, etc.

A “network access token” may include a token that is used to conduct a transaction using a transaction network including a processing network computer. A network access token may be subject to domain restrictions (e.g., noted above) and may be accompanied by a cryptogram that can be used to identify a domain in which the network access token is used. The network access token may have the attributes of the above-described token.

A “supplemental access token” may include a token that is supplemental to a token such as a network access token. In some embodiments, the supplemental access token may be stored by a resource provider so that it can be used for subsequent transactions. In some embodiments, the supplemental access token may have the same or different format as the network access token. In some embodiments, the supplemental access token is not transmitted over a payment network, but is used to initiate a transaction with a gateway computer.

An “interaction amount” may be an amount that is associated with an interaction such as a transaction. An interaction amount could be an initial amount, or a subsequent amount that is less than an initial amount.

An “initial amount” can be an amount that is initially determined, before any reductions or alterations of an amount can take place.

A “value indicator” may be any suitable direct or indirect indicator of value. Examples of value indicators may be discrete amounts (e.g., monetary amounts), points, loyalty account numbers, coupons, etc.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCW (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

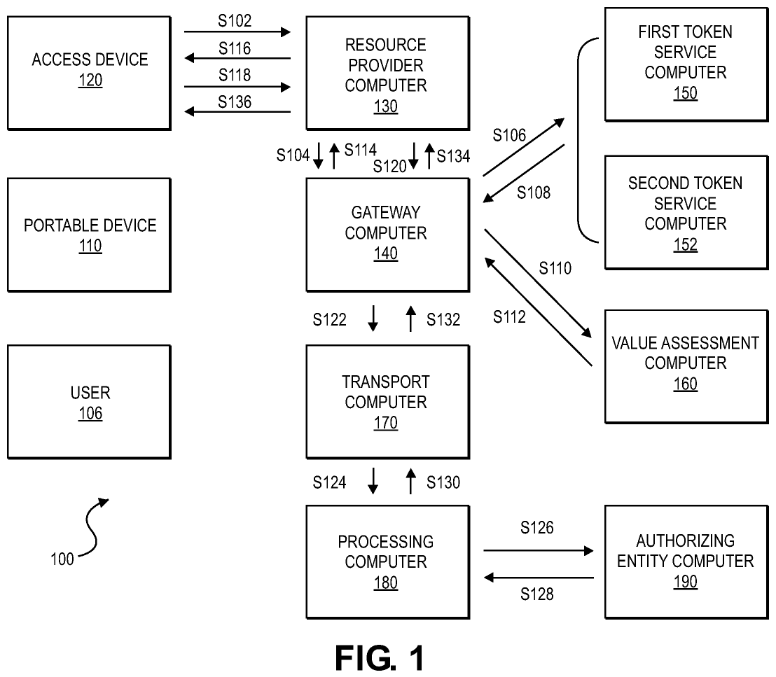

FIG. 1 shows a system 100 according to an embodiment. Although a specific set of components is shown in FIG. 1, embodiments of the invention may have more or less components.

The system 100 comprises a gateway computer 140 in operative communication with a resource provider computer 130, and one or more token service computers including a first token service computer 150 and a second token service computer 152. Note that two token service computers are shown for purposes of illustration, but there may be more token service computers in other embodiments.

The gateway computer 140 may also be in operative communication with an authorizing entity computer 190 via a transport computer 170 and a processing computer 180. The resource provider computer 130 may be in communication with an access device 120. A user 106 may operate or otherwise interact with the access device 110. In some embodiments, the access device 120 may be a computer such as a laptop computer or a mobile phone operated by the user 106. In other embodiments, the access device 120 may be a terminal such as a point of sale terminal operated by a resource provider such as a merchant. If the access device 120 is a terminal such as a point of sale terminal, the user 106 may also be in possession of a portable device 110, which may be an access card such as a payment card or a transit access card.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

A method according to an embodiment of the invention can be described with respect to FIG. 1.

In step S102, the user 106 may contact a resource provider (e.g., a merchant) operating the resource provider computer 130 using the access device 120 (e.g., a laptop computer) to conduct an interaction such as a transaction. In some embodiments, the resource provider computer 130 may operate a host site such as a merchant Website. In this example, the access device 120 may be a mobile phone or a computer operated by the user 106, and the resource provider computer 130 may be merchant computer operating a host site such as a merchant Website. In some embodiments, the user 106 may wish to make a purchase using the portable device 110, which may be a payment card such as a credit, debit, or prepaid card. The user 106 may select one or more resources (e.g., goods or services) to purchase, and may enter access data such as a PAN (primary account number) associated with the payment card into the access device 120.

In step S104, the resource provider computer 130 generates a token request message to obtain a network access token such as a network access payment token for the access data that is received from the access device 120. Once generated, the resource provider computer 130 may transmit the network token request message to the gateway computer 140. The token request message may also include interaction data such as a real credential, a total amount spent, a description of the resources desired by the user 106 (e.g., line items), resource identifier data (e.g., SKU or stock keeping unit data), etc.

In step S106, the gateway computer 140 can receive the interaction data for the transaction and can analyze the access data (e.g., the PAN) in the token request message. Once the gateway computer 140 analyzes the access data, the gateway computer 140 can determine an appropriate token service computer. In this regard, the gateway computer 140 may contain a directory that can map authorizing entity identification numbers (e.g., BINs or bank identification numbers) to appropriate token service computers. The gateway computer 140 then transmits a network token request message to an appropriate token service computer, which could be the first token service computer 150.

In step S108, the first token service computer 150 can obtain the network access token. The network access token can be obtained in any suitable manner. For example, the network access token can be pre-generated and retrieved from a database. Alternatively, the network access token can be generated from data associated with the user 106. For example, the network access token can be generated using the access data (e.g., a primary account number).

After the network access token is obtained, the first token service computer 150 can generate a network token response message comprising the network access token and an optional network token reference identifier such as a payment reference identifier. A network token reference identifier (e.g., a payment reference identifier) may be uniquely associated with the network access token, but it cannot be used to obtain resources such as goods and services. In some embodiments, the network access token reference identifier can be a value that can be used by an entity such as a resource provider to track use of a network access token. The network access token identifier may also have any suitable format. In some embodiments, the network access token reference identifier may be in the same or different format as the network access token (e.g., both may be sixteen digit numbers). After the network access token and the network token reference identifier are obtained, the first token service computer 150 may then send the network token response message comprising the network access token and the network access token reference identifier to the gateway computer 140.

Alternatively or additionally, the gateway computer 140 could transmit the access data, the network access token, and/or the interaction data to the value assessment computer 160 (e.g., a loyalty service computer) as in step S110. If the interaction data is transmitted to the value assessment computer 160, it can return loyalty details specific to the user's loyalty account. Such details may include a unique account identifier, points, user incentives (e.g., coupons), etc.

After the gateway computer 140 receives the network token response message from the first token service computer 150 in step S108, and optionally after the gateway computer 140 receives any loyalty details from the value assessment computer 160 in step S112, the gateway computer 140 can obtain a supplemental access token that is associated with the network access token reference identifier, the network access token, and the optional loyalty details. In some embodiments, the supplemental access token may be generated by the gateway computer 140. For example, the supplemental access token may be mathematically generated using various user specific inputs such as the network access token, the credential, and/or the payment reference identifier. In another example, the supplemental access token may have been pre-generated and stored in a database at the gateway computer 140.

In some embodiments, the supplemental access token and optionally the network access token reference identifier may be transmitted to the resource provider computer 130 and may be stored therein (e.g. in step S114). In some embodiments, the resource provider computer 130 may only store the supplemental access token and possibly the network access token reference identifier. By doing so, only the supplemental access token is needed for the resource provider to conduct future transactions and to interact with the value assessment computer 160 in future transactions. Further, by doing so, the real credentials (e.g., PAN) is protected, since obtaining the supplemental access credential does not compromise any real credentials.

In some embodiments, referring back to step S110, the gateway computer 140 can then transmit a value inquiry message (e.g., a loyalty inquiry message) comprising the supplemental access token to the value assessment computer 160 (e.g., a loyalty provider computer). The value inquiry message may contain the supplemental access token, and optionally the network access token reference identifier. The value inquiry message may include any appropriate transaction details such as the amount of the current transaction, an identifier for the resource provider, the total amount spent by the user 106 at the particular resource provider operating the resource provider computer 130, any coupons or incentives provided by the user 106 for the current transaction, etc.

The value assessment computer 160 may also generate a value indicator based on the data in the value inquiry request message. The value indicator may be any suitable indicator of value. For example, after receiving the value inquiry request message, the value assessment computer 160 may use the network access token reference identifier to identify a loyalty account of the user 106, and determine how much of a discount the user might receive by also evaluating the amount of the current transaction. In this example, the user value assessment computer 160 may determine that the amount of the transaction may be $100 and the value assessment computer 160 may determine that the transaction can be reduced by $10 due to the user's past purchases at the resource provider operating the resource provider computer 130. The value assessment computer 160 may then generate a value indicator of $10.

Again referring back to step S112, after receiving the value inquiry request message, the value assessment computer 160 can generate a value inquiry response message (e.g., a loyalty inquiry response message) comprising the value indicator and the network access token reference identifier. The value assessment computer 160 may then transmit the value inquiry response message to the gateway computer 140. The value inquiry response message may comprise the value indicator. The value indicator may be a discrete value as noted above, or it may be another value such as a total points balance, loyalty account information, and the like.

In some embodiments, the gateway computer 140 may initiate the generation of an authorization request message that includes an interaction amount that is based at least in part on the value indicator in the value inquiry response message. In some embodiments, the gateway computer 140 may itself generate an authorization response message to be transmitted to the authorizing entity computer 190 via the transport computer 170 and the processing computer 180. For example, the gateway computer 140 may take the value indicator from the value inquiry response message, and apply it to any initial transaction amount for the transaction. For example, the gateway computer 140 could take the initial transaction amount $100 and reduce the initial transaction amount by a value indicator of $10 to form an interaction amount. In other embodiments, the value indicator may be a points total in a user's loyalty account. The points total may be used by the gateway computer 140 to determine a reduced transaction amount for the current transaction. Once the interaction amount is determined, the gateway computer 140 could then generate and transmit an authorization request message comprising at least the network access token and the interaction amount to the authorizing entity computer 190.

In other embodiments, the gateway computer 140 can initiate the generation of an authorization request message by communicating with the resource provider computer 130. For example, in step S114, the value indicator such as loyalty information including the total points balance and the loyalty account information can be transmitted from the gateway computer 140 to the resource provider computer 130.

At step S116, the resource provider computer 130 transmits the data to the access device 120, which can display or otherwise provide loyalty account information to the user 106. The user 106 can then decide if they want to use the value indicator (e.g., loyalty points) in order to reduce the amount the transaction. In step S118, the user 106 may indicate an intent to use the value indicator for the current transaction by selecting an appropriate button on the access device 120.

In step S120, based on this decision, the resource provider computer 130 can generate an authorization request message comprising the supplemental access token and the interaction amount. The interaction amount may be an amount that is less than the initial amount for the transaction, after the value indicator has been applied to the transaction. The resource provider computer 130 may then transmit the authorization request message to the gateway computer 140. The authorization request message may also contain details of any value indicator (e.g., loyalty points) used so that any balance at the value assessment computer 160 can be updated.

In steps S122 and S124 the gateway computer 140, upon receiving the authorization request message, may substitute the network access token for the supplemental access token in the authorization request message. The gateway computer 140 may then then transmit the authorization request message with the network access token and the interaction amount to processing computer 180 via the transport computer 170.

The processing computer 180 may then substitute a real credential associated with the network access token for the network access token in the authorization request message. In step S126, the processing computer 180 may then transmit the authorization request message to the authorizing entity computer 190.

After receiving the authorization request message, the authorizing entity computer 190 may evaluate the data in the authorization request message. The authorizing entity computer 190 may evaluate the amount in the authorization request message to determine if the user 106 has sufficient funds or credit in the user's account. The authorizing entity computer 190 may also perform a fraud analysis on the authorization request message to determine if the transaction being conducted is potentially fraudulent. The authorizing entity computer 190 may then determine if the transaction for the interaction amount is approved or declined.

At step S128, the authorizing entity computer 190 may generate an authorization response message comprising the real credential and an approval or decline indicator. After generating the authorization response message, the authorizing entity computer 190 may transmit the authorization response message to the processing computer 180. After receiving the authorization response message, the processing computer 180 can substitute the network access token for the real credential in the authorization response message.

At steps S130 and S132, the processing computer 180 can then transmit the authorization response message to the gateway computer 140. The gateway computer 140 can then substitute the supplemental access token for the network access token in the authorization response message.

In step S134, the authorization response message including the supplemental access token may be transmitted by the gateway computer 140 to the resource provider computer 130. In step S136, a transaction confirmation message may be transmitted to the access device 120. In some embodiments, the transaction confirmation message may be the authorization response message with the supplemental access token. Conformation messages may also be transmitted to the value assessment computer 160 so that the value assessment computer 160 can adjust any loyalty amounts in any accounts that it maintains.

At a later point in time, a clearing and settlement process can be performed between the transport computer 170, the processing computer 180, and the authorizing entity computer 190. The resource provider computer 130 may provide a file including transactions and their associated supplemental access tokens to the gateway computer 140. The gateway computer 140 may then substitute the network access tokens for the supplemental access tokens, and may provide the updated file to the transport computer 170. The transport computer 170 or the processing computer 1480 may communicate with the first token service computer 150 to obtain the real access data (e.g., real primary accounts numbers) associated with the network access tokens, and may then perform the clearing and settlement process.

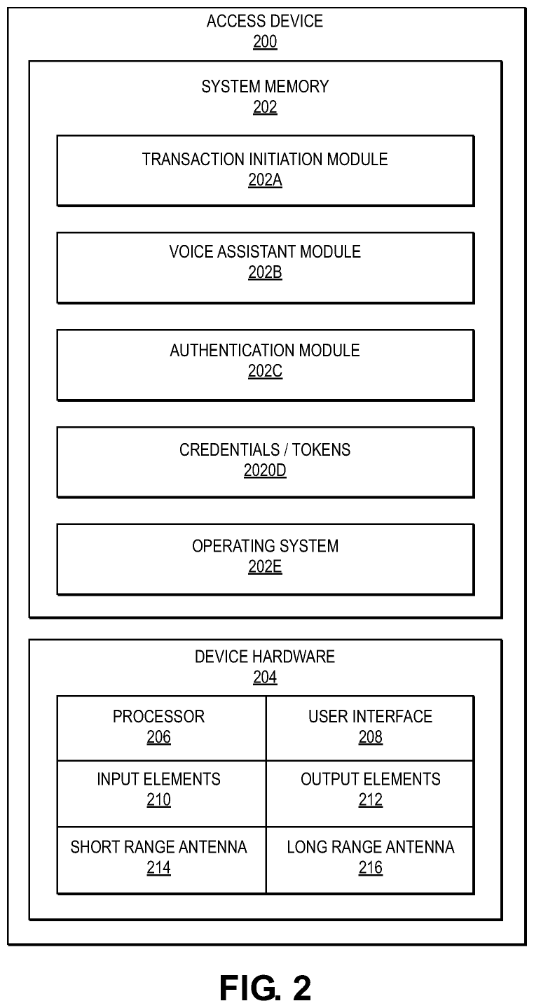

FIG. 2 illustrates an access device 200 according to an embodiment. Access device 200 may include device hardware 204 coupled to a system memory 202.

Device hardware 204 may include a processor 206, a short range antenna 214, a long range antenna 216, input elements 210, a user interface 208, and output elements 212 (which may be part of the user interface 208). Examples of input elements may include microphones, keypads, touchscreens, sensors, etc. Examples of output elements may include speakers, display screens, and tactile devices. The processor 206 can be implemented as one or more integrated circuits (e.g., one or more single core or multicore microprocessors and/or microcontrollers), and is used to control the operation of access device 200. The processor 206 can execute a variety of programs in response to program code or computer-readable code stored in the system memory 202, and can maintain multiple concurrently executing programs or processes.

The long range antenna 216 may include one or more RF transceivers and/or connectors that can be used by access device 200 to communicate with other devices and/or to connect with external networks. The user interface 208 can include any combination of input and output elements to allow a user to interact with and invoke the functionalities of access device 200. The short range antenna 809 may be configured to communicate with external entities through a short range communication medium (e.g. using Bluetooth, Wi-Fi, infrared, NFC, etc.). The long range antenna 819 may be configured to communicate with a remote base station and a remote cellular or data network, over the air.

The system memory 202 can be implemented using any combination of any number of non-volatile memories (e.g., flash memory) and volatile memories (e.g. DRAM, SRAM), or any other non-transitory storage medium, or a combination thereof media. The system memory 202 may store computer code, executable by the processor 805, for performing any of the functions described herein.

The system memory 202 may also store a transaction initiation module 202A, a voice assistant module 202B, an authentication module 202C, credentials 202D, and an operating system 202E. The transaction initiation module 202A may include instructions or code initiating and conducting a transaction with an external device such as a resource provider computer. The voice assistant module 202B may comprise code, executable by the processor 206, to receive voice segments, and generate and analyze data corresponding to the voice segments. The authentication module 202C may comprise code, executable by the processor 206, to authenticate a user. This can be performed using user secrets (e.g., passwords) or user biometrics.

System memory 202 may also store credentials and/or tokens 202D. Credentials may also include information identifying the access device 200 and/or the user of the access device 200. Examples of credentials may include a public key associated with the access device 200 and/or a user of the access device 200, a digital signature (e.g., the public key of the access device 200 signed by a key of the authentication system), payment credentials, biometric data (e.g., biometric samples or templates), etc.

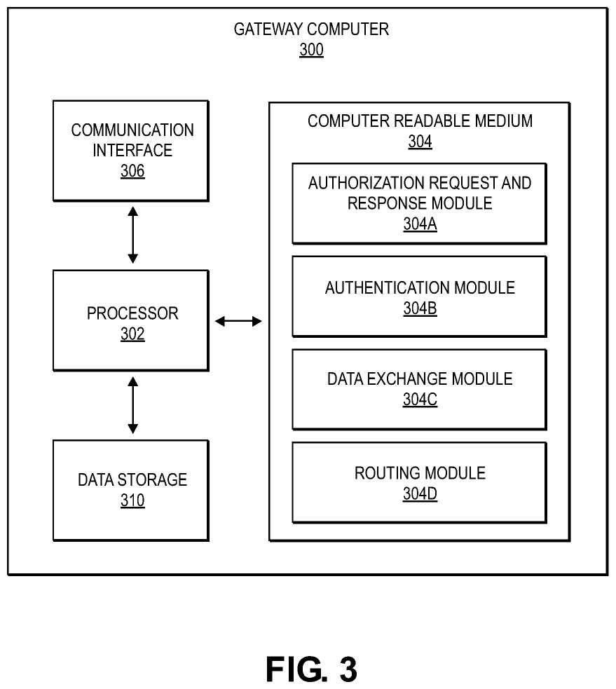

FIG. 3 shows a block diagram showing components in an exemplary gateway computer 300. The gateway computer 300 may comprise a processor 302. It may also comprise a computer readable medium 304, a communication interface 306, and a data storage 310 operationally coupled to the processor 302.

The data storage 310 may contain data that maps network access tokens, network access token identifiers, and supplemental access tokens. The data storage 310 may also comprise data from one or more value assessment computers. For example, value indicators associated with the network access tokens, network access token identifiers, and supplemental access tokens may be included in the data storage 310.

The computer readable medium 304 may store code or instructions for allowing gateway computer 300 to operate in the manner described herein. The instructions may be executed by the processor 302. For example, the computer readable medium 304 may comprise code or instructions for receiving interaction data for a transaction with a resource provider interacting with an access device; responsive to receiving the interaction data, transmitting a network token request message to a token service computer; receiving, from the token service computer, a network token response message comprising a network access token; obtaining a supplemental access token associated with the network access token; transmitting a value inquiry message comprising the supplemental access token to a value assessment computer; receiving a value inquiry response message comprising a value indicator from the value assessment computer; and initiating generating an authorization request message comprising an interaction amount that is based at least in part on the value indicator in the value inquiry response message.

The computer readable medium 304 may further comprise an authorization request and response module 304A, an authentication module 304B, a data exchange module 304C, and a routing module 304D. The authorization request and response module 304A may comprise software which will allow the gateway computer 300 to generate authorization request messages, and process authorization request and response messages. The authentication module 304B may include code for authenticating a user or an access device used by the user. The data exchange module 304C may comprise code, executable by the processor 302, to exchange data with value assessment and token service computers. The routing module 304D may comprise code, executable by the processor 302, to route messages to their intended destinations. The routing module 304D may comprise code, executable by the processor 302, to evaluate a BIN in access data such as a PAN, and to identify an appropriate token service provider computer based upon the BIN. In some embodiments, the routing module 304D may contain a table which lists the BIN and a corresponding network address of an appropriate token service computer.

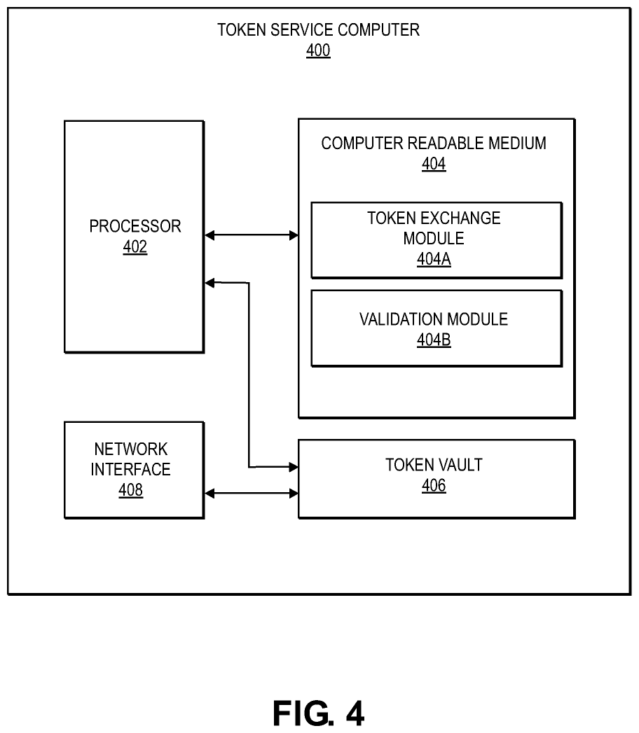

FIG. 4 shows a token service computer 400. The token service computer 400 includes a processor 402 and a computer readable medium 404, a token vault 406, and a network interface 408 coupled to the processor 402.

The computer readable medium 404 may comprise a token exchange module 404A and a validation module 404B.

The token vault 406 may store network access tokens and their associated credentials in a database. The token vault 406 may store data in a database such as an Oracle™ database.

The tokenization exchange module 404A may comprise code that causes the processor 402 to provide network access tokens. For example, the token exchange module 404A may contain logic that causes the processor 402 to generate a payment token and/or associate the payment token with a set of payment credentials. A token record may then be stored in a token record database indicating that the payment token is associated with a certain user or a certain set of payment credentials.

The validation module 404B may comprise code that causes the processor 402 to validate token requests before a payment token is provided. For example, validation module 404B may contain logic that causes the processor 402 to confirm that a token request message is authentic by decrypting a cryptogram included in the message, by confirming that the payment credentials are authentic and associated with the requesting device or by assessing risk associated with the requesting device.

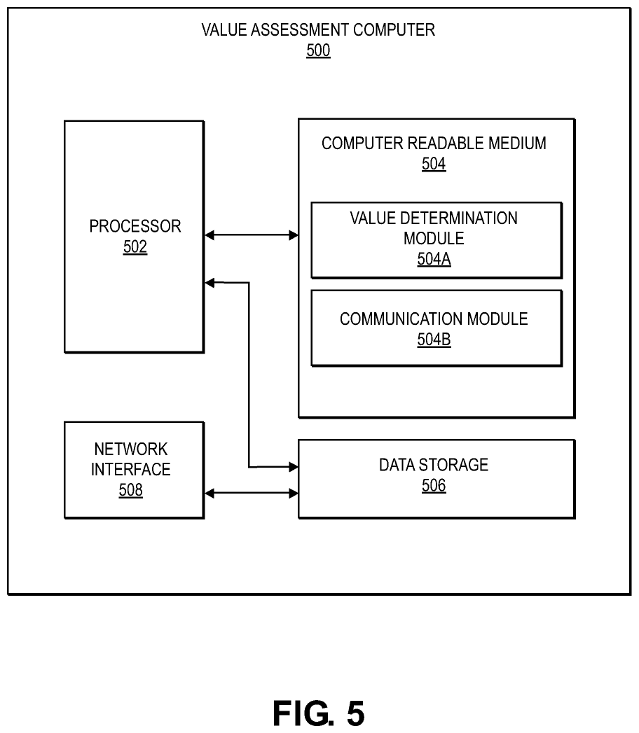

FIG. 5 shows a block diagram of a value assessment computer 500 according to an embodiment. The value assessment computer 500 may comprise a processor 502, which may be coupled to a computer readable medium 504, data storage 506, and a network interface 508. The data storage 506 may value assessment data. Value assessment data may comprise any suitable data including account identifiers (e.g., loyalty account numbers), balances, coupons, etc.

The computer readable medium 504 may comprise a number of software modules including a value determination module 504A and a communication module 504B.

The value determination module 504A may comprise code that can cause the processor 502 to determine a value indicator in response to receiving a value inquiry request message. The determination of the value indicator may occur in any suitable manner. For example, in some embodiments, the value indicator may be a loyalty account number or a balance, and may simply be retrieved from the data storage 506. In other embodiments, the value determination process may involve the calculation or determination of the value indicator. For example, the value determination module 504A and the processor 502 may receive information about the transaction being conducted and may determine the value indicator based upon that information. As an illustration, the value indicator may be determined based upon the initial interaction amount and/or an identifier of the resource provider. For example, the value indicator may be determined to be higher if the initial interaction amount is high and lower if the initial interaction amount is low.

The communication module 504B may comprise code that causes the processor 502 to generate messages, forward messages, reformat messages, and/or otherwise communicate with other entities.

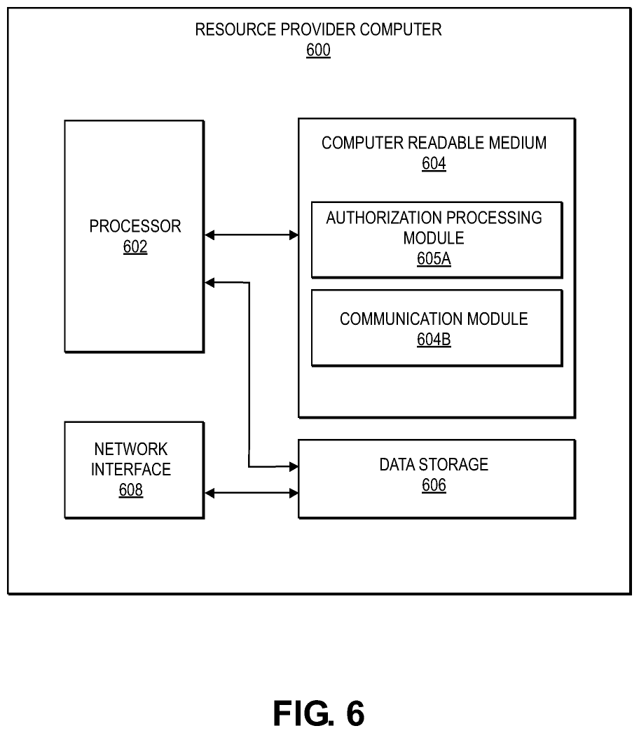

FIG. 6 shows a block diagram of a resource computer 600 according to an embodiment. The resource provider computer 600 may comprise a processor 602, which may be coupled to a computer readable medium 604, data storage 606, and a network interface 608. The data storage 606 may contain data such as supplemental access token identifiers as well as network access token reference identifiers.

The computer readable medium 604 may comprise a number of software modules including an authorization processing module 604A and a communication module 604B. The computer readable medium 604 may comprise code, executable by the processor 602 for implementing a method comprising: transmitting, by a resource provider computer, interaction data to a gateway computer; in response to transmitting the interaction data to the gateway computer, receiving, by the resource provider computer from the gateway computer, a value indicator; generating, by the resource provider computer, an authorization request message comprising a supplemental access token; and transmitting, by the resource provider computer, the authorization request message to the gateway computer, which modifies the authorization request message to include a network access token associated with the supplemental access token and transmits the modified authorization request message to an authorizing entity computer for authorization.

The authorization processing module 604A may comprise code that can cause the processor 602 to generate and process authorization response messages and to process authorization request messages.

The communication module 604B may comprise code that causes the processor 602 to generate messages, forward messages, reformat messages, and/or otherwise communicate with other entities.

Embodiments of the invention have a number of advantages. In other systems, a payment token reference identifier returned by a token service computer can be used by merchants to identify customers and create their own loyalty service. However, in embodiments of the invention, a resource provider such as a merchant does not have to use the payment token reference identifier. The resource provider only needs to use a supplemental access token to keep track of transactions, conduct transactions, as well as perform value assessment processing (e.g. loyalty processing) while keeping real access data such as real credentials (e.g., a PAN) secure, thus being PCI (payment card industry) compliant. The supplemental access token may be used for processing a payment, unlike a payment token reference identifier.

Further, in embodiments of the invention, token/loyalty account information can be created/updated before the payment is processed, giving the user the choice as to how they wish to proceed in the current transaction (e.g., use loyalty points to reduce payment amount or not?). Embodiments of the invention can be card brand/payment method agnostic. The resource provider (e.g., a merchant) can have one integration point for all their card brands/payment methods. They do not have to build separate systems that integration to each of the issuers and network token/loyalty services that they might interact with. Overall, embodiments of the invention simplify resource provider systems and improve efficiency relative to conventional systems.

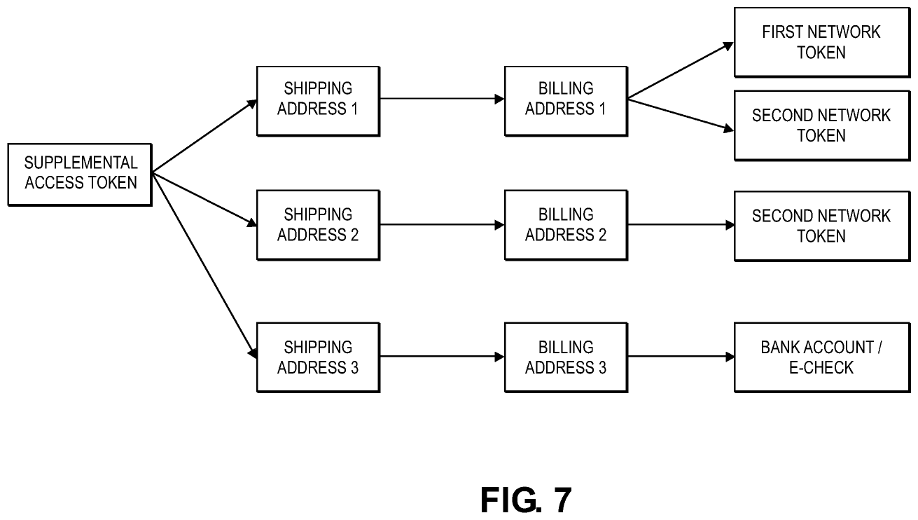

With reference to the diagram in FIG. 7, a supplemental access token can be a single reference point for multiple billing, shipping and payment details. This can mean that a user can redeem points with a gateway computer using any of their billing/shipping details or payment methods. For example, a merchant can make a request to tokenize a consumer's billing/shipping details and Visa card. A supplemental access token can be returned to the merchant that has a billing address token, a shipping address token and Visa network token (e.g., a first network token) associated with it. This supplemental access token can also have the user's loyalty account information associated with it. When the same user contacts the merchant at a later time with new billing/shipping details and a MasterCard payment card (which may be used to generate a second network token), the merchant will be able to tokenize these details and associate them with the existing supplemental access token. Again, points can be accrued with the value assessment computer against the supplemental access token. For future transactions, the user can be given the choice as to which billing/shipping/payment details they would like to use for a transaction, and they can obtain or use points or other value indicators in any desired combination of their choice.

In embodiments of the invention, a user can be automatically enrolled in a loyalty system when buying something for the first time in store using opt-in language from the store clerk. If the user then subsequently buys something online with the same card, name/address details could be captured and added to the consumers payment token/loyalty profile so that the next time they use their card in store they could be referenced by their name to provide a personal shopping experience.

Users can be surprised when they receive loyalty rewards without having to explicitly register via a long form or provide PII (personal identifiable information) data to a cashier for a loyalty program. Alternatively, merchants can enroll users in the loyalty program via online consent via Web checkout in the terms and conditions during a standard eCommerce/mobile checkout experience.

The loyalty service and points system can use historical transaction data to calculate and manage points/rewards for the consumers account. The loyalty services can be used by a single merchant managing their company loyalty/rewards program or could be configured in such a way that would allow different merchants to run promotions together and allow points accumulation and usage across their storefronts. For example, merchants may want to encourage card spending in a small town/locality. The loyalty service could then add offers to encourage this behavior. Offers such as double points when a card is used within a town (using Geolocation) could be configured by a group of co-operating merchants.

The loyalty system can provide merchant reporting and offer recommendations based on customer spend pattern/behavior to increase customer retention and customer loyalty. The loyalty service could also be configured in such a way that would allow multiple consumers with the same billing address to collect and spend points in a shared account using multiple cards. The loyalty service can work with fraud web services that can track account takeover and fraud patterns using behavior analytics.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
receiving, by a gateway computer, interaction data for an interaction with a resource provider interacting with an access device;
responsive to receiving the interaction data, transmitting, by the gateway computer, a network token request message to a token service computer;
receiving, by the gateway computer from the token service computer, a network token response message comprising a network access token;
obtaining, by the gateway computer, a supplemental access token associated with the network access token;
transmitting, by the gateway computer, a value inquiry message comprising the supplemental access token to a value assessment computer;
receiving, by the gateway computer, a value inquiry response message comprising a value indicator from the value assessment computer; and
initiating generating, by the gateway computer, an authorization request message comprising an interaction amount that is based at least in part on the value indicator in the value inquiry response message.

2. The method of claim 1, further comprising:
transmitting, by the gateway computer, the value indicator to the access device, wherein the access device presents the value indicator to a user at the access device.

3. The method of claim 2, wherein the access device confirms use of the value indicator in the interaction.

4. The method of claim 1, wherein the authorization request message comprises the network access token.

5. The method of claim 1, further comprising:
transmitting, the authorization request message to an authorizing entity computer via a processing computer.

6. The method of claim 5, further comprising:
receiving an authorization response message from the authorizing entity computer; and
transmitting, the authorization response message to the access device.

7. The method of claim 6, further comprising:
replacing, in the authorization response message, the network access token with the supplemental access token.

8. The method of claim 1, wherein the interaction amount is a second amount, and wherein the access device generates a first amount for the interaction, and the second amount is the first amount reduced by the value indicator.

9. A gateway computer comprising:
a processor; and
a computer readable medium coupled to the processor and containing instructions for causing the processor to perform a method comprising:
receiving interaction data for an interaction with a resource provider interacting with an access device;
responsive to receiving the interaction data, transmitting a network token request message to a token service computer;
receiving, from the token service computer, a network token response message comprising a network access token;
obtaining a supplemental access token associated with the network access token;
transmitting a value inquiry message comprising the supplemental access token to a value assessment computer;
receiving a value inquiry response message comprising a value indicator from the value assessment computer; and
initiating generating an authorization request message comprising an interaction amount that is based at least in part on the value indicator in the value inquiry response message.

10. The gateway computer of claim 9, wherein the network access token is 16 digits long and has a same format as a real credential.

11. The gateway computer of claim 9, wherein the supplemental access token has a different format as the network access token.

12. The gateway computer of claim 9, wherein obtaining the supplemental access token comprises generating the supplemental access token.

13. The gateway computer of claim 9, wherein generating the authorization request message comprising the interaction amount that is based at least in part on the value indicator in the value inquiry response message comprises subtracting the value indicator from an initial amount to obtain the interaction amount.

14. A method comprising:
transmitting, by a resource provider computer, interaction data to a gateway computer;
in response to transmitting the interaction data to the gateway computer, receiving, by the resource provider computer from the gateway computer, a value indicator;
generating, by the resource provider computer, an authorization request message comprising a supplemental access token; and
transmitting, by the resource provider computer, the authorization request message to the gateway computer, which modifies the authorization request message to include a network access token associated with the supplemental access token to form a modified authorization request message, and transmits the modified authorization request message to an authorizing entity computer for authorization.

15. The method of claim 14, wherein the resource provider computer stores the supplemental access token.

16. The method of claim 14, wherein the supplemental access token has a same format as the network access token.

17. The method of claim 14, wherein the gateway computer is in communication with a token service computer and a value assessment computer.

18. The method of claim 14, wherein the gateway computer transmits a value inquiry message comprising the supplemental access token to a value assessment computer, and receives an value inquiry response message comprising the value indicator from the value assessment computer.

19. The method of claim 18, further comprising:
presenting, by the resource provider computer, the value indicator to a user.

20. The method of claim 14, wherein the resource provider computer comprises a data storage storing a plurality supplemental access tokens for different users.

21.-22. (canceled)
